(19) United States
(12) Patent Application Publication
(10) Pub. No.: US 2018/0253785 A1
(43) Pub. Date: Sep. 6, 2018

(54) Wardrobe Assistant Device(s) for Matching Apparel

(71) Applicants: Wai Keung Chong, Kirkland, WA (US); Linda Zachariah, Mercer Island, WA (US)

(72) Inventors: Wai Keung Chong, Kirkland, WA (US); Linda Zachariah, Mercer Island, WA (US)

(21) Appl. No.: 15/902,878

(22) Filed: Feb. 22, 2018

Related U.S. Application Data
(63) Continuation-in-part of application No. 14/276,923, filed on May 13, 2014, now abandoned.
(60) Provisional application No. 61/916,590, filed on Dec. 16, 2013.

(51) Int. Cl. G06Q 30/06

(52) U.S. Cl. CPC G06Q 30/0643; G06Q 30/0625

(57) ABSTRACT

Embodiments of this application describe systems and methods for an apparel matching communication device associated with a selected garment that may include at least a transceiver, a rechargeable power supply, indicator(s), and a processor, to transmit a wake-up signal to a plurality of other sensors associated with a corresponding plurality of other garments, wherein the wake-up signal includes an identification of the selected garment. In embodiments, the sensor may receive a response signal from one or more similar plurality of other sensors, indicating an apparel match between the selected garment and an associated matching garment. In some embodiments, the sensors may include suggestions associated with a user's “body double” by matching information associated with the consumers, such as reviews, size data, style preferences, etc. Other devices and embodiments may be described and claimed.

### CROSS-REFERENCE TO RELATED APPLICATIONS

This application claims priority to non-provisional application Ser. No. 14/276,923, entitled, Systems and Methods for Matching Consumers According to Size, filed May 13, 2014, which in turns claims priority to provisional application No. 61/916,590, filed on Dec. 16, 2013, both which are hereby incorporated by reference in their entireties.

### TECHNICAL FIELD

This described technology relates generally to sensors for apparel, shoes, accessories, and the like, more particularly, to an apparel matching system to assist users in determining outfit combinations or suggestions for various articles of clothing.

### BACKGROUND

The proliferation of online styling services over the past few years has demonstrated the desire that consumers have for streamlining everyday wardrobe choices as well as efficiency in making online purchases. For example, online styling services, e.g., STITCH FIX® or TRUNK CLUB®, may send various outfit combinations to their customers on a subscription or on-demand basis. A shipment might include 6-10 items including a combination of apparel (pants, skirts, shirts, shorts, etc.,) as well as outerwear, shoes, jewelry and accessories, and the like, Users typically have the choice to purchase one or more items in a delivery or return all of the items. Despite a high rate of returns, due to poor fit or other style issues, the popularity of such services continues to rise, due to the convenience of having one's own remote personal stylist without ever having to leave home. In addition, the popularity of online fashion boards, e.g., POLYVORE®, PINTEREST®, and the like, demonstrate the desire that users have for finding outfit suggestions which may incorporate the latest trends, classic fashion looks, new purchases, all the while leveraging items already in their closet.

### BRIEF DESCRIPTION OF THE DRAWINGS

FIG. 1 is an example apparel matching system including a plurality of apparel matching sensors associated with a corresponding plurality of articles of clothing in accordance with various embodiments of the present disclosure.

FIG. 2 illustrates outfit combinations/suggestions indicated by a plurality of apparel matching sensors in accordance with various embodiments of the present disclosure.

FIG. 3 is a diagram of an example apparel matching sensors that may be located in/on or otherwise integrated with one or more of the articles of clothing associated with FIGS. 1 and 2, in accordance with various embodiments of the present disclosure.

FIG. 4 is a block diagram of an example method associated with the embodiments of FIGS. 1-3.

FIG. 5 illustrates an example apparel matching environment in accordance with various embodiments of the present disclosure

FIG. 6 illustrates a plurality of apparel matching sensors that may be integrated with a plurality of hangers in accordance with various embodiments of the present disclosure.

FIG. 7 is a block diagram of an example method in accordance with various embodiments of the present disclosure.

FIG. 8 is a block diagram of another example method in accordance with various embodiments of the present disclosure.

FIG. 9 is a block diagram associated with the example methods of FIGS. 7 and 8.

FIG. 10 illustrates an example computing system/device suitable for use as a wardrobe-assistant device, other client device, and/or apparel matching server to practice various aspects of the invention in accordance with various embodiments of the present disclosure.

### DETAILED DESCRIPTION OF EMBODIMENTS

Embodiments of this application describe sensors for assisting users including consumers or other actors match apparel. In embodiments, apparel may include one or more “article(s) of clothing” and may refer to any type of clothing worn on the body but may also refer to any suitable accessories including scarves, jewelry, and/or footwear, such as for example, but not limited to, sandals, shoes, or boots. For the purposes of this Description, “article of clothing” may also be used interchangeably with “garment.”

In embodiments, an apparel matching sensor may be associated with a selected article of clothing. In embodiments, the apparel matching sensor may include a transceiver, a memory, a rechargeable power supply, and a processor. The apparel matching sensor may further include one or more indicators and/or detector(s) in embodiments. In some embodiments, the apparel matching sensor of a selected article of clothing may transmit an identification signal to similar other apparel matching sensors associated with a corresponding plurality of other articles of clothing. In some embodiments, the identification signal may be a wake-up signal accompanied by an identification of the selected article of clothing. In embodiments, the apparel matching sensor may subsequently receive a response signal indicating an apparel match between the selected article of clothing and a matching article of clothing.

Additional devices, methods, and systems are described, including a wardrobe-assistant device to assist in providing information related to the apparel match to the apparel matching sensors and/or directly to the user. In some embodiments, the wardrobe-assistant device may receive the identification signal from the selected article of clothing and display a matching outfit for the user to view. In some embodiments, the matching outfit may incorporate articles of clothing in the user's wardrobe associated with other apparel matching sensors. In embodiments, the wardrobe-assistant device may sync or otherwise receive information from a remote apparel matching server located in a network or cloud to allow the wardrobe-assistant device to provide the matching outfits to the user. In embodiments, the remote apparel matching server may provide fashion match suggestions/combinations to the wardrobe-assistant device as well as receive information related to an article of clothing (e.g., style, brand, size, fit, etc.) associated with a user's closet or wardrobe.

Note that in some embodiments, the remote apparel matching server may help users find a “body double” by matching information associated with the consumers, such as clothing reviews, size data, style preferences, frequency of wear, etc. In embodiments, a computing device, such as the remote apparel matching server, may receive information related to a fit of a first article of clothing for a first user as well as information related to a fit of a second article of clothing for a second user. In embodiments, the information may be received from the wardrobe-assistant device or directly from an apparel matching sensor. In embodiments, the information may include any information relevant to a purchase decision by a user, such as for example, but not limited to, fit, style, comfort, color, value, and quality of the article of clothing. In embodiments, the computing device may use the received information to determine a match between the first user and the second user based on similar experiences with respect to an article of clothing, in particular, the size of the particular item of clothing. In embodiments, the computing device may provide information related to the match to the wardrobe-assistant device or other client device which may assist a user in making future purchase decisions related to one or more articles of clothing. In embodiments, the consumer or user may login and browse information related to the match on a wardrobe-assistant device, or other client device including, but not limited to, a laptop, desktop, and/or a wireless mobile device, e.g., smartphone, tablet, personal digital assistant (“PDA”), etc.

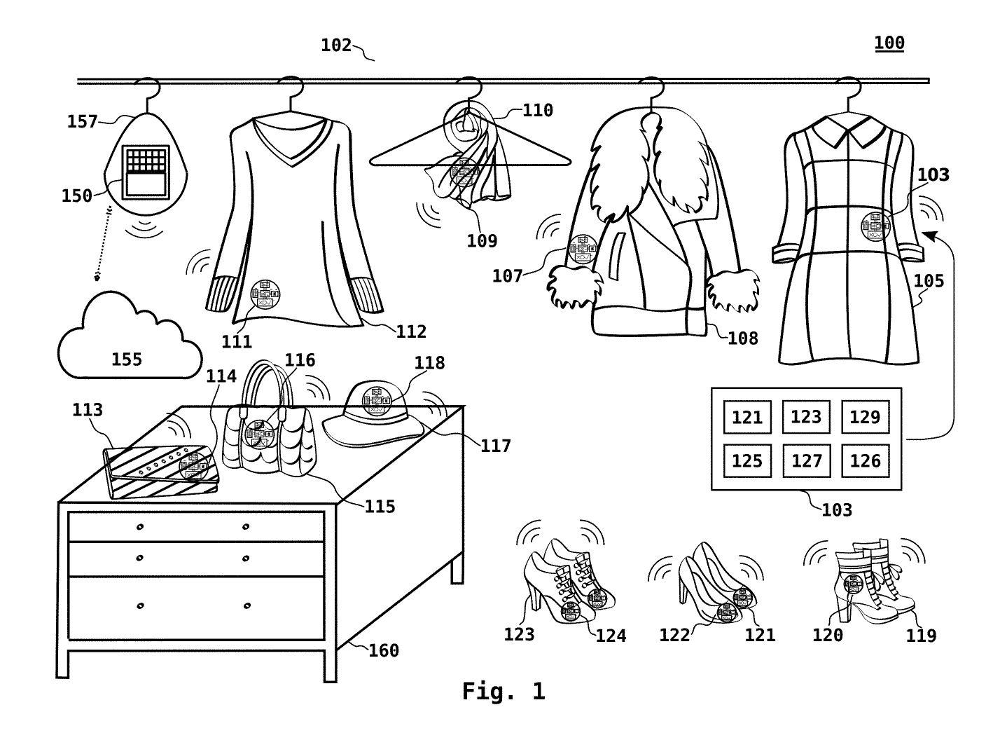

FIG. 1 illustrates an example apparel matching system 100 in accordance with various embodiments of the present disclosure. As noted above, “articles of clothing” or “garment’ may be used interchangeably and in addition to including articles of clothing such as pants, jeans, leggings, shorts, dresses, skirts, shirts, blouses, undergarments, jackets, coats and the like, may also include handbags, belts, shoes, scarves, ties, jewelry, sunglasses, hats, and/or other complementary articles for wear by a user. In the illustrated embodiment, apparel matching sensors (“sensors”) may be associated with a respective corresponding plurality of articles of clothing, e.g., dress 105, coat 108, scarf 110, and sweater 112. In embodiments, apparel matching sensor 103 may be located in/on or otherwise integrated with dress 105. As noted above, articles of clothing also refers to handbags, shoes, scarves, ties, jewelry, hats, and the like. Accordingly, in the embodiment, apparel matching sensors 114, 116, 118, 124, 122 and 120 may be integrated in/on or associated with respective corresponding articles of clothing, pocketbook 113, purse 115, hat 117, shoe boots 123, pumps 121, and boots 119. In embodiments, sensor 103 may include components such as a processor 121, a transceiver 123, a rechargeable power supply 125, a memory or storage 126, an indicator 127, and a detector 129. In embodiments, apparel matching sensors 107, 109, 111, 114, 116, 118, 124, 122 and 120 may have similar components as example sensor 103 and may be located in/on/integrated with the respective article of clothing.

Furthermore, in embodiments, a wardrobe-assistant device 150 may be located proximally to the plurality of articles of clothing, e.g. typically in or near a chest or dresser 160 or wardrobe/closet 102 including one or more of the plurality of articles of clothing and in some cases, integrated with a hanger or hanging device 157.

In embodiments, a user may desire outfit suggestions for a selected article of clothing (or “garment”), for example, dress 105. In embodiments, an outfit suggestion may include a group of one or more complementary garments located in/on or otherwise proximally located to his or her closet/wardrobe 102. As noted above, apparel matching sensor 103 may be located in/on or otherwise associated with dress 105. Accordingly, in embodiments, the user may activate detector 129 of apparel matching sensor 103. In embodiments, detector 129 may include a detector such as a pressure sensor, such as, e.g., a button or a touch sensor. In embodiments, the pressure sensor may activate apparel matching sensor 103 (“sensor 103”) and cause sensor 103 to transmit an identification signal to a plurality of other apparel matching sensors, e.g., apparel matching sensors or sensors 107, 109, 111, associated with a respective corresponding plurality of articles of clothing, jacket 108, scarf 110, and sweater 112 or apparel matching sensors 114, 116, 118, 120, 122, and 124 associated with respective pocketbook 113, purse 115, hat 117, boots 119, pumps 121, and shoe boots 123. Note that in other embodiments, detector 129 may be a voice detector and sensor 103 may thus be voice-activated.

In embodiments, the identification signal may be a wake-up signal that may include or be accompanied by an identification of the selected article of clothing, dress 105. In response to the wake-up signal, in embodiments, sensor 103 may receive a response signal from one or more of the plurality of apparel matching sensors indicating an apparel match between dress 105 and an associated matching article of clothing in the corresponding plurality of other articles of clothing. In various embodiments indicator 127 may include one or more lights (e.g., light emitting diodes (LEDs), organic LEDs), speakers, or other suitable indicator. In some embodiments, indicator 127 may also include a flexible screen. In various embodiments, indicator 127 may include a pattern of lights or sounds to indicate an apparel match with the selected article of clothing. In embodiments, a pattern of lights or sounds may indicate a classification associated with the apparel match. For example, dress 105 may match (e.g., be included in a plurality of potential combinations) more than one pair of shoes, handbag, and/or hosiery or leggings (not shown) in closet/wardrobe 102. In embodiments, there may be a hierarchical ranking or classification of potential combinations, e.g., preferred outfits or less-preferred outfits, depending on current fashion trends or the weather. In embodiments, classifications may include, e.g., work, evening, casual, athletic, weekend outfits, etc. For example, in some embodiments, dress 105 may be coordinated with a particular pair of shoes or accessories depending upon whether the outfit is for work or weekend brunch, etc.

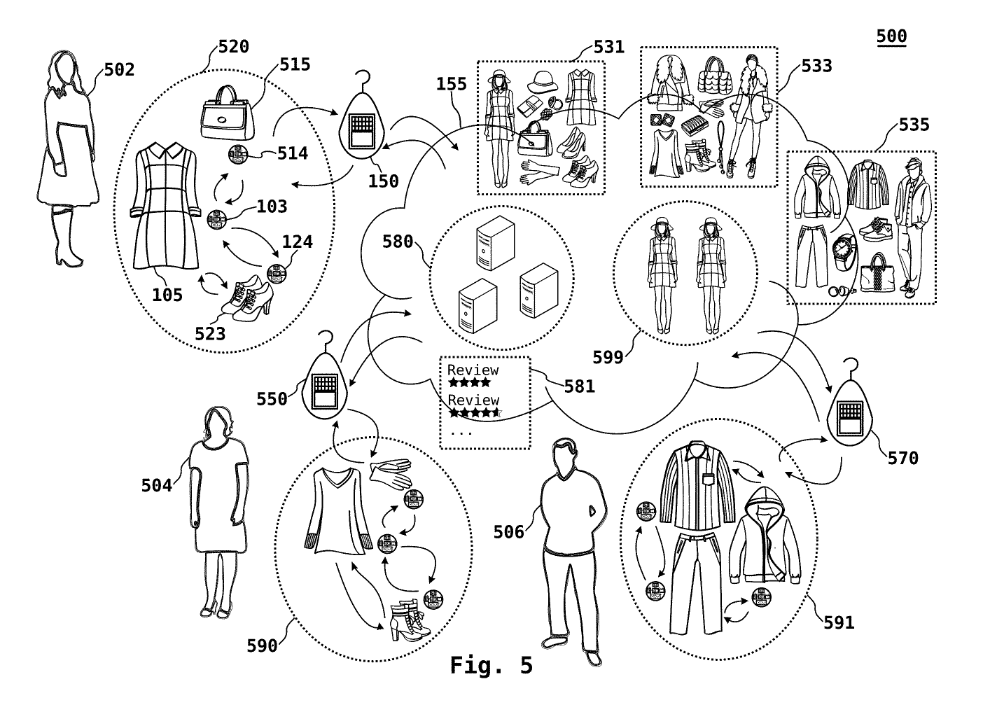

Note that in the embodiment, the other apparel matching sensors include components as shown in sensor 103 but are not enlarged to maintain clarity in FIG. 1. Furthermore, note that in embodiments, articles of clothing 113, 115, and 118 including respective sensors 114, 116, and 118 are shown as located on dresser 160, but may also be located inside dresser 160 during activation, charging, or the like. Thus, in some embodiments, the user may prefer to receive indications via sound (as noted above where indicator 127 may be a speaker) from particular articles of clothing that may not be immediately visible. Note that in various embodiments, the user may set such preferences (including classification preferences for potential combinations as discussed above) via wardrobe-assistant device 150. In embodiments, wardrobe-assistant device 150 may be communicatively coupled to a cloud 155 to receive and provide information to one or more remote apparel matching servers (further shown and described in connection with FIG. 5) related to the plurality of articles of clothing in a user's closet/wardrobe, e.g., identities of the articles of clothing including a brand, style, size, and frequency of wear by the user and other information related to an outfit suggestion for the user. In embodiments, wardrobe-assistant device 150 may also include a display screen to display outfit suggestions.

Note that in various embodiments, an apparel matching sensor may be assigned a unique identification by a retailer or manufacturer that may sell or manufacture an associated article of clothing. In some embodiments, the apparel matching sensor may be assigned an identification by a consumer via wardrobe-assistant device or other client device.

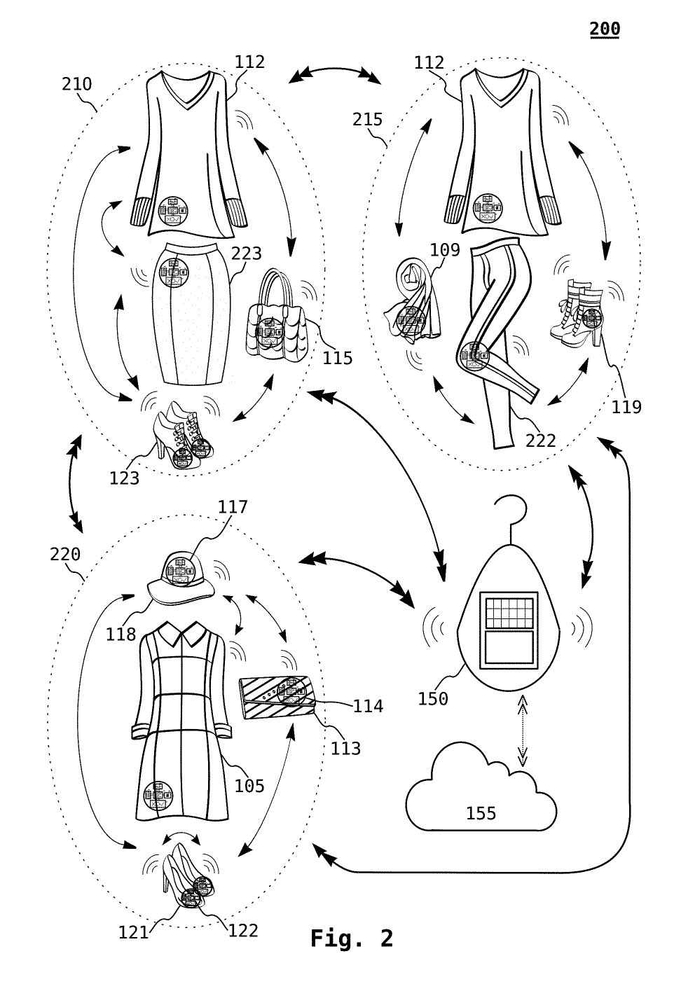

FIG. 2 illustrates outfit groupings 210, 215, and 220, representing outfit combinations or suggestions including one or more of the plurality of articles of clothing of FIG. 1. Accordingly, as described in connection with the example of FIG. 1, sensor 103 may receive a response signal from one or more of the plurality of apparel matching sensors (e.g., sensors 114, 117, and 122 of grouping 220) indicating an apparel match between selected dress 105 and potential matching articles of clothing, pocketbook 113, hat 118, and pumps 121. In embodiments, wardrobe-assistant device 150 may include an inventory of the plurality of articles of clothing associated with wardrobe/closet 102. In some embodiments, wardrobe-assistant device 150 may periodically sync information and data with cloud 155, providing information about the plurality of articles of clothing (e.g., identification including type, brand, style, size, etc.) and receiving outfit suggestions and other information in return. In embodiments, wardrobe assistant device 150 may provide outfit suggestion information including identification of relevant associated articles of clothing to each of the plurality of sensors. Note that in some embodiments, wardrobe-assistant device 150 may provide an outfit suggestion including identification of a garment associated with a body double of the user and available for purchase through wardrobe assistant device 150 or other computing device. In some embodiments, the outfit suggestion may identify a garment in an outfit suggestion for future wear that may not be located in wardrobe/closet 102 but may be purchased online through wardrobe-assistant device 150 or at a nearby brick-and-mortar retailer.

Accordingly, in embodiments, apparel matching sensors 114, 117, and 122 may transmit a response signal indicating an apparel match or grouping to sensor 103 of dress 105 as described above in connection with FIG. 1. In embodiments, each of the plurality of sensors associated with pocketbook 113, pumps 121, and hat 118 may communicate with sensor 103 as well as communicate directly with each other. For example, in embodiments, each of the plurality of sensors 114, 117, and 122, associated with pocketbook 113, hat 118, and pumps 121 may communicate with each other prior to sending the response signal to sensor 103 of dress 105. For example, in embodiments, prior to providing the response to sensor 103, one or more of the plurality of sensors may communicate with a sensor of the additional article of clothing to confirm availability. In some embodiments, each of the plurality of sensors may confirm that another article of clothing in the grouping 220 is present, clean, and/or otherwise available. In some embodiments, one or more of the plurality of sensors may provide a suggestion to sensor 103 (and/or the other sensors) of a substitute article of clothing for grouping 220 when one or more other articles of clothing of a potential group may be missing (e.g. sensors of grouping 220 communicate with sensors of groupings 210 or 215).

In embodiments, sweater 112 may be associated with more than one outfit suggestion, e.g., associated with both groupings 210 and 215. For example, in embodiments, grouping 210 may include a work outfit with shoe boots 123, skirt 223, and handbag 115. In embodiments, in grouping 215, sweater 112 may also be grouped as a weekend outfit with e.g., pants 222, boots 119, and scarf 110. Accordingly, as noted above, in embodiments, a number, letter, text, sound, and/or particular color or pattern of lights or sounds may indicate a classification (or hierarchy) associated with the outfit suggestion. For example, a blue indicator light displayed by each of the plurality of sensors of grouping 210 may indicate a work outfit while a green indicator light displayed by each of the plurality of sensors of grouping 215 may indicate a weekend or casual outfit. As noted above, in various embodiments, a user may set preferences related to classifications of outfits as well as indicator notifications via wardrobe-assistant device 150 or other user device such as a mobile phone, laptop, tablet, desktop, or other computing device. In some embodiments, the pattern of sounds may include a song or musical arrangement played in combination by indicators 127 of various groupings. In some embodiments, sound may be played concurrently with lights or a pattern of lights.

Note also that in embodiments, although women's and men's clothing is shown in the Figures, embodiments also may include children's clothing. Accordingly, a song or musical arrangement may include very simple tones and/or children's music to any preferred selection from a streaming music service, music library, or stored music files, that may be associated with a user.

Note that in embodiments, a user may utilize a scanner or reader of wardrobe-assistant device 150 to scan each of the sensors associated with the plurality of articles of clothing so that wardrobe-assistant device 150 may store an inventory of articles of clothing associated with the user. In other embodiments, wardrobe-assistant device 150 may ping each of apparel matching sensors and/or automatically receive information from apparel matching sensors located in or on one or more of the plurality of articles of clothing. In embodiments, articles of clothing without sensors may be entered manually via the wardrobe-assistant device of other computing device.

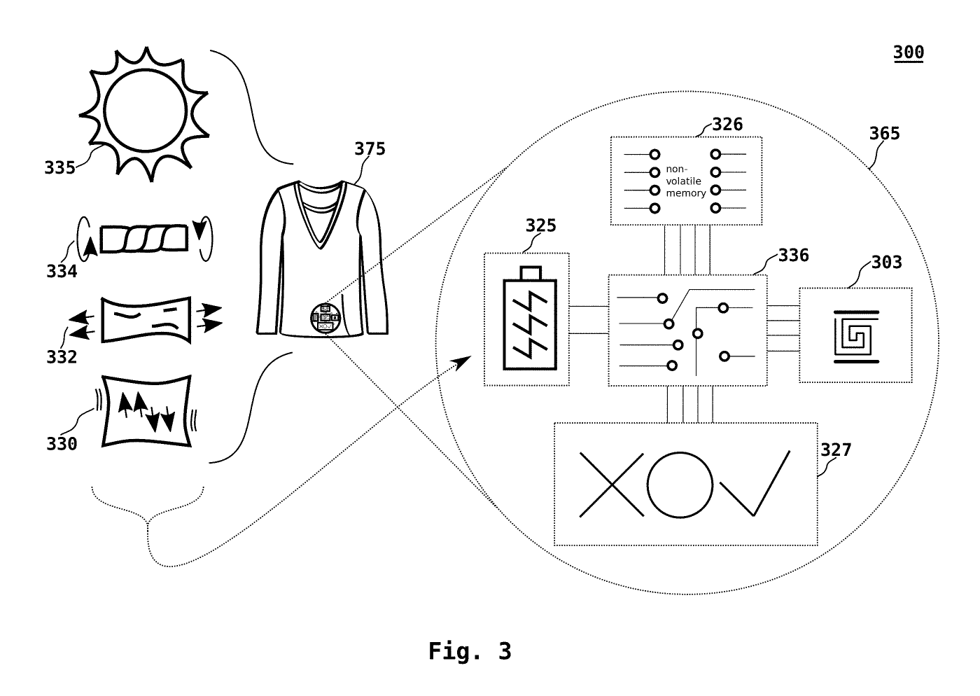

Next, FIG. 3 illustrates an example apparel matching sensor 365 (“sensor 365”) that may be associated with FIGS. 1 and 2. In embodiments, sensor 365 may include a near-field communication (NFC) device or NFC tag 303 coupled to a logic circuit 336, a rechargeable power supply 325, a memory 326, and an indicator 327 that may, in some embodiments, include a flexible display. In embodiments, sensor 365 may be included in a garment 375 that may be made partly or completely of a washable electrically-conducting polymer coated fabric. For example, in some embodiments, the conducting polymer may include PEDOT, a conducting polymer, poly(3, 4-ethylenedioxytiophene). In some embodiments, garment fibers may be immersed in PEDOT or otherwise coated with PEDOT to convert garment fibers into electrically conducting fibers and/or yarn. Accordingly, in embodiments, garment 375 may include a power generating fabric that may provide an electric current to charge power supply 325.

In embodiments, power supply 325 may include a rechargeable battery, e.g., a stretchable battery made of fabric which may be charged by yarn elements 330, 332, 334, and/or that may be rechargeable with solar power 335 or other light. In embodiments, photo sensors may be integrated or included on fabric of garment 375 to provide solar power 335 or other light to power supply 325. In some embodiments, kinetic energy may also recharge power supply 325 alone or in combination with solar power 335 or other light. In embodiments, yarn elements 330, 332, and 334 may generate a current when stretched or moved in various directions as indicated by the arrows in FIG. 3. In embodiments, garment 375 or portions of garment 375 may be made of a stretchable fabric that may include carbon nanotubes. In embodiments, the carbon nanotubes may include, e.g., twistron, a type of yarn that may harvest energy from kinetic energy, such as e.g., generated by a user's breathing motion. Accordingly, in embodiments, an electric current may be generated when the fabric is exposed to light, exposed to body heat, or otherwise worn and handled (e.g., putting on garment 375 or other movement while wearing garment). In embodiments, fabric of garment 375 may serve as a thin electrochemical energy harvesting device that may generate electrical current from a full range of motion. In some embodiments, fabric of garment 375 may include stretchy micro-super capacitors made of ribbons of graphene. In some embodiments, power supply 325 may include a textile-based bio battery.

In embodiments, NFC tag 303 may include a flexible NFC tag to identify an associated article of clothing and may be embeddable into garment 375. In embodiments, NFC 303 may support two-way communication including peer-to-peer (P2P) communications. Accordingly, in embodiments, wireless communication between garments or between garments and wardrobe-assistant device 150 may occur via radiofrequency (RF) communication while wardrobe-assistant device 150 may include an NFC reader/writer. In embodiments, the communication may use Internet Protocol (e.g. IPv4 or IPv6) addressing that may also be mapped using a hashing function.

In embodiments, memory 326 may include a non-volatile memory that may be integrated, (in some cases, embroidered) as part of garment 375. In embodiments, the non-volatile memory may include a flexible and washable magnetic-based fabric data storage integrated into fabric of garment 375. Additionally, in embodiments, logic circuit 336 may be included in, e.g., processor 121 of sensor 103 of FIG. 1. In embodiments, logic circuit 336 may be printed directly onto garment 375 using a conductive ink. In various embodiments, substantially all or a portion of apparel matching sensor 365 may be included in a “patch” or portion of fabric that may be ironed or otherwise attached to an article of clothing that may not have been manufactured with an integrated sensor.

Furthermore, in embodiments, display 327 may include fiber-based organic light emitting diodes (OLED). In embodiments, display 327, which may include e.g., indicator 127 of FIG. 1, may be integrated directly into garment 327. In embodiments, and as is known in the art, OLED technology may be flexible and washable as well as allow light to be emitted when electrical current is applied. Accordingly, in embodiments, fiber elements 330, 332, and 334 may generate electrical current to power indicator 127. In embodiments and as discussed in relation to FIGS. 1 and 2, various colors and/or patterns of colors and/or sounds may be associated with various groupings and/or classifications of apparel match.

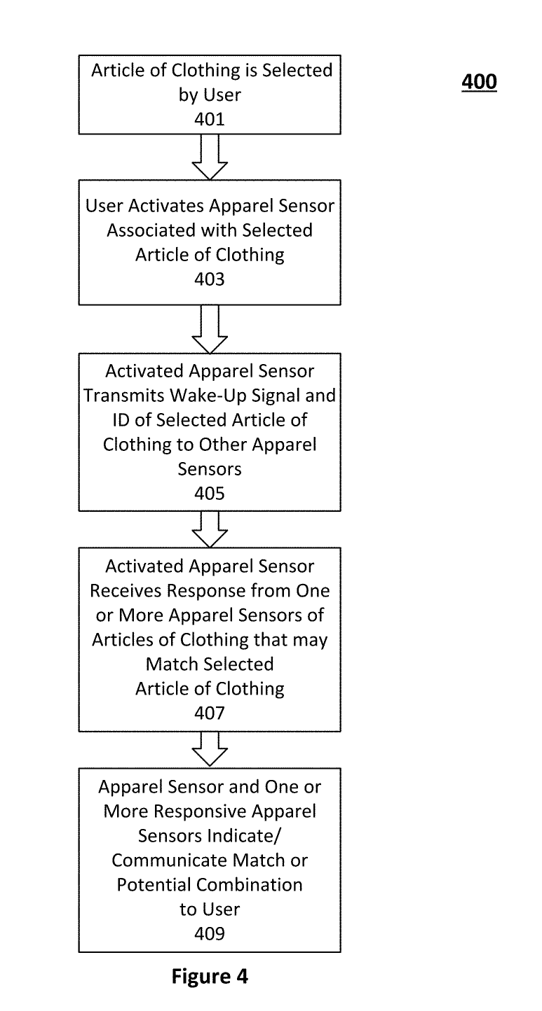

Next, FIG. 4 illustrates a block diagram 400 associated with FIGS. 1-3. In embodiments, at a block 401, an article of clothing may be selected by a user (e.g., dress 105). In embodiments, at a next block 403, the user may activate an apparel matching sensor associated with the selected article of clothing (e.g., sensor 103). Next, in embodiments, at block 405, the activated apparel matching sensor may transmit an identification which may include a wake-up signal associated with or otherwise identified as originating from the selected article of clothing, to other apparel sensors. At a next block 407, in embodiments, the activated apparel sensor may receive a response from one or more apparel sensors associated with articles of clothing that may match the selected article of clothing. At block 409, in embodiments, the one or more responsive apparel sensors may indicate a match or potential combination to the user. Note that in various other embodiments (not shown), the activated apparel matching sensor may transmit the identification to another device (e.g. wardrobe-assistant device 150) concurrently (or instead of to the other plurality of sensors) so that the wardrobe-assistant device may display outfit suggestions or otherwise inform the user of various outfit suggestions or groupings.

FIG. 5 illustrates an example environment 500 for an apparel matching system in accordance with various embodiments of the present disclosure. In embodiments, environment 500 may include one or more remote apparel management or apparel matching servers 580 located in a network or cloud 155 and wardrobe-assistant devices 150, 550, and 570 associated with respective users 502, 504 and 506. In the illustrated embodiments, each of users 502, 504, and 506 may be associated with a plurality of articles of clothing including or associated with a corresponding plurality of apparel matching sensors. For example, in the embodiment, a plurality of apparel matching sensors for user 502 may include e.g., sensors 103, 124, and 514 associated with respective handbag 515, dress 105, and shoes 523 of grouping 520. In embodiments, wardrobe-assistant devices 550 and 570 associated with a user 504 and 506 and respective groupings 590 and 591 including associated sensors (not individually numbered to maintain clarity in the Figure) may also be communicatively coupled to network or cloud 155.

In embodiments and as discussed previously with respect to FIGS. 1-3, sensors, e.g., sensors 103, 124, and 514 may be on or integrated into a material or fabric of associated articles of clothing, e.g., respective handbag 515, dress 105, and shoes 123. In various other embodiments, sensors 103, 124, and 514 may be associated with a hanger or area/shelves/furniture for storing respective handbag 515, dress 105, and shoes 123. In embodiments, apparel matching servers 580 may assist in determining fashion matching suggestions based on information, represented by, e.g., 531, 533, 535, related to possible matching combinations or groupings, or various articles of clothing or garments. In various embodiments, combinations 531, 533, 535, may be suggested combinations that may be based on information collected from various sources such as, for example, but not limited to, designers, stylists, online or brick-and-mortar retailers, clothing manufacturers, fashion bibles, fashion matching algorithms, websites, or feeds including information on current trends (including e.g., Pinterest®, Twitter®, Facebook®, Snap Chat® and the like), celebrity sightings, and/or users (e.g., user input related to and/or data related to previous outfits worn or related information about preferred combinations or types of preferred combinations input by a user). In embodiments, suggested combinations may also include information from online reviews 581 made by similar users who may have similar fashion patterns or preferences or that may be a body double of the user. In embodiments, a wardrobe-assistant device 150, 550, or 570 of a user may be communicatively coupled to cloud 155 to receive information 531, 533, 535 from apparel matching servers 580.

In embodiments, apparel matching servers 580 may receive an identifier (e.g., included in an RFID tag as described in connection with FIG. 3) of an apparel matching sensor associated with one or more of users, e.g., users 502, 590, or 591. In embodiments, the identifier may be passed to apparel matching servers 580 from, e.g. wardrobe-assistant device 150, 550, or 570, or may be received directly from an apparel matching sensor (e.g., sensor 103). In embodiments, apparel matching servers 580 may use the received identifier to determine an apparel match between a particular article of clothing and one or more matching articles of clothing and transmit information associated with the apparel match to the wardrobe-assistant device. In various embodiments, an identifier of the apparel matching sensor may be provided to the apparel matching server to allow the remote management server to further determine a body double suggestion for a user based on a size and style of the article of clothing and to transmit the body double suggestion to the wardrobe-assistant device. In embodiments, the apparel matching server may transmit information associated with the apparel match to the wardrobe-assistant device including an image of a suggested outfit combination or grouping.

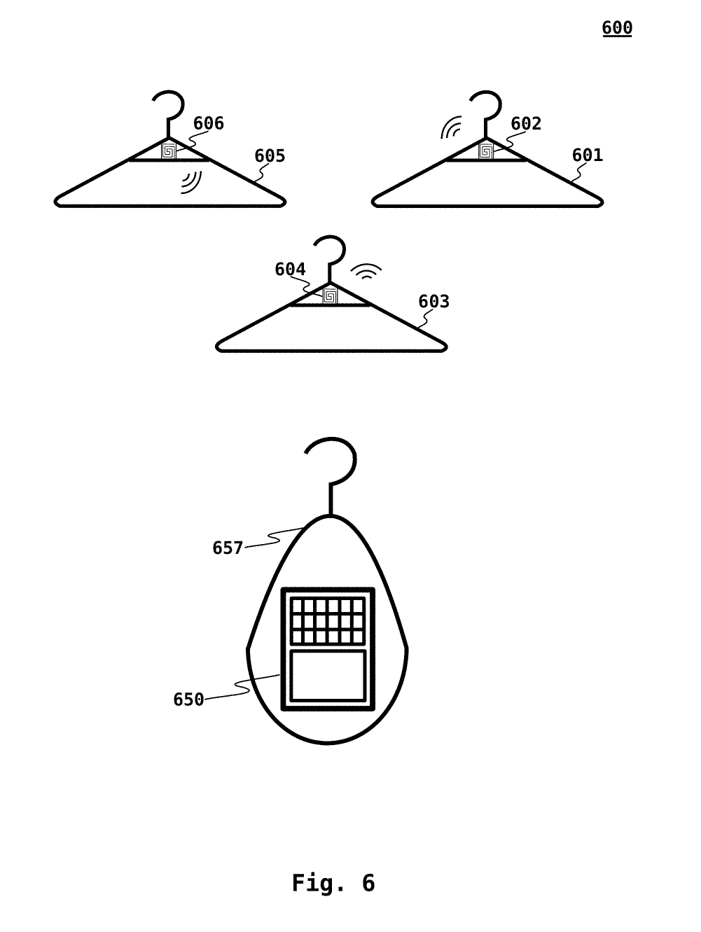

FIG. 6 illustrates alternative embodiments including apparel matching sensors that may be used in a similar manner to the apparel matching sensors of FIGS. 1 and 2. In embodiments, apparel matching sensors 602, 604, and 606 may be located in, on, or otherwise integrated into respective smart clothes hangers 601, 603, and 605. In embodiments, smart clothes hangers 601, 603, and 605 may each be assigned to an associated article of clothing via a wardrobe-assistant device 650 or other computing device. In embodiments, wardrobe-assistant device 650 may be communicatively coupled to a network or cloud to receive and provide information to an apparel matching server related to the plurality of articles of clothing in a user's closet/wardrobe, e.g., identities of the articles of clothing including a brand, style, size, and frequency of wear by the user and other information related to an outfit suggestion for a user. As noted above, in embodiments, smart clothes hangers 601, 603, and 605 may each be assigned to an article of clothing via wardrobe-assistant device 450 or other computing device. In various embodiments, apparel matching sensors 602, 604, and 606 may periodically check in with a user via wardrobe-assistant device 650 or other computing device to determine whether an article of clothing is located on a correct smart clothes hanger according to the assignment. In various embodiments, in addition to performing functions as described in connection with FIGS. 1 and 2, smart clothes hangers 601, 603, and 605 may also assist in keeping track of inventory, frequency of use or wear, dry-cleaning frequency, and/or location of an assigned article of clothing. In embodiments, information from smart clothes hangers 601, 603, and 605 may be synced with wardrobe-assistant device 650 which may be synced with the cloud, edge network, FOG, or other network. In various embodiments as appropriate, rather than a smart clothes hangar, equivalents, e.g. a shoe tree for shoes or other storage container may include an integrated apparel matching sensor.

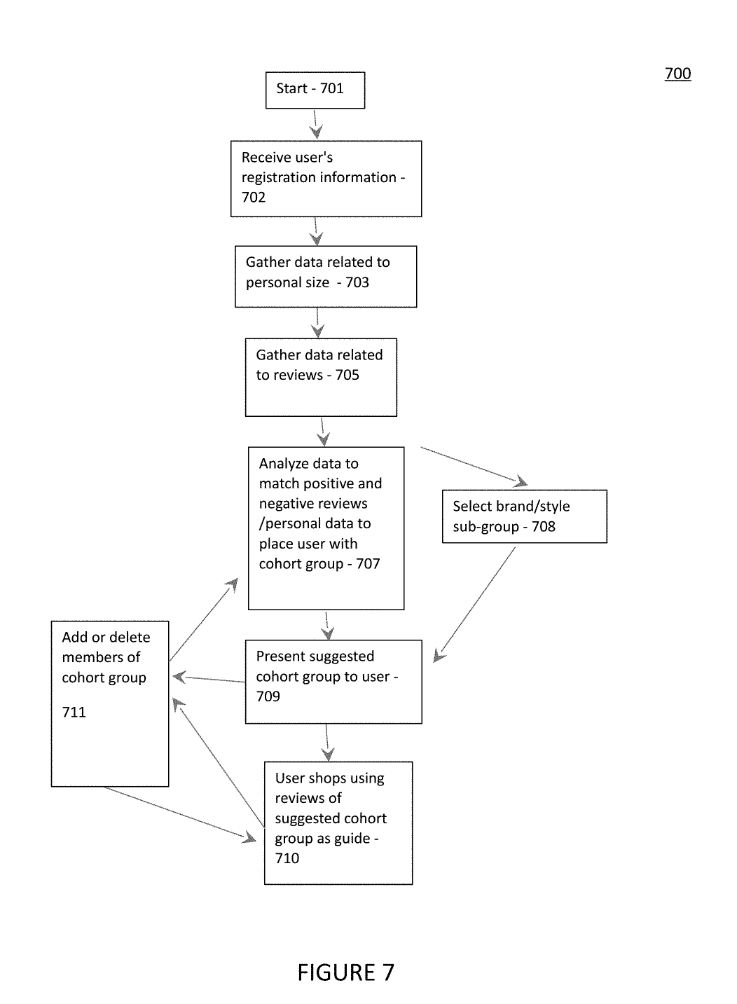

FIG. 7 illustrates an exemplary method 700 according to embodiments of the present invention. In embodiments, a consumer matching engine located at apparel matching servers, e.g., apparel matching servers 580 of FIG. 5, may provide a user with a cohort of “body doubles” (e.g. represented as element 599 of FIG. 5) in order to facilitate purchasing decisions and/or suggested outfit combinations. In embodiments, at a block 702, at an initial visit by a user to a website received from a computing device (e.g. apparel matching servers 580) implementing embodiments of the invention, the user may register as a user of the website on a client device or wardrobe-assistant device 150. In embodiments, this may include a name, address, or other identifying information. In various other embodiments, the user may choose to remain anonymous and be identified only through a “body double” user ID. In embodiments, registration includes selecting a user name and password. At a next block 703, data may be gathered related to the user's size. Thus, in embodiments, information related to the user's size may be entered by the user. In some embodiments, information related to the user's style preferences may also be entered. In one embodiment, the information includes the size that the user typically wears for particular articles of clothing in one or more particular brands (e.g. size 4, in Banana Republic™). In embodiments, different sizes for different types of articles of clothing can be entered, e.g. tops, pants, skirts, shirts, shoes or boots, etc. In various embodiments, size, style, preference data, and the like can be collected via apparel matching sensors of FIGS. 1-5. Optionally, information from the user such as actual physical measurements associated with the user can be entered via the wardrobe-assistant device. The user may be prompted to enter optional data related to, for example, but not limited to, height, weight, bra size, measurements for hips, chest, waist, inseam, sleeve length, foot, and/or neck. In embodiments, since particular sizes in particular brands may vary for different articles of clothing, measurements may be extrapolated from the data. In embodiments, where actual measurements are not entered or only some measurements, the computing device may generate/produce general measurement ranges associated with the user from the entered data. In other embodiments, data collected above, including actual physical measurements associated with the user, may be determined at the apparel matching server from information collected via the apparel matching sensors of FIGS. 1-5.

In embodiments, at a next block, information or data related to reviews of clothing written or made by the user may be received at a block 705. This may include for example, an actual review entered directly into the present website corresponding to an article of clothing, e.g., jeans or a shoe/boot purchased or tried on, or text of (or a link to) a review that was previously completed on a retailer's online website for the article of clothing. In some embodiments, the review does not need to have text, it can merely have a rating or answers to one or more questions, e.g., whether the item was a “keeper” as well as other questions/ratings related to fit, comfort, value, style, etc. In embodiments, the user may be prompted to enter size information manually for the article of clothing that was reviewed. In embodiments, the user can scan an apparel matching sensor of an associated garment into the wardrobe-assistant device. In other embodiments, the user can scan in or enter numbers associated with a Quick Response Code (“QR code”), Universal Product Code (“UPC code”), or other identifying code or number corresponding to the article of clothing or item. In embodiments, the code may be included on a smart tag or other tag associated with the item and provide basic identification of the article of clothing. In embodiments, the code may also provide a size of the article of clothing. Note that accessories such as, but not limited to, jewelry, sunglasses, belts, scarves, hats, gloves, watches, and hair accessories etc., may also be included as an item or article of clothing in the context of this disclosure.

At a next block 707, the data gathered at block 703 and/or 705 may be analyzed to place the user/consumer into a cohort group (e.g., see body doubles 599 of FIG. 5). Thus in embodiments, positive and/or negative reviews (e.g., see reviews 581 of FIG. 5) as well as personal size and style preference data received from apparel matching sensors and/or wardrobe assistant device of FIGS. 1-5 may be used to match users. In various embodiments, the user may enter reviews into a wardrobe assistant device. In embodiments, the cohort group includes users whose reviews for particular articles of clothing (in embodiments, having same or similar sizes) are similarly positive or negative and are thus a ‘body double’ for each other. In various embodiments, this generation of a cohort group may include just a few people or up to as many people that have similar data that correlate to the user and would provide potentially useful purchase/review information. In embodiments, different extrapolation methods depending upon the data available as gathered in blocks 703 and/or 705 may be used to determine the cohort group. For example, users that do not have reviews to enter can simply enter what size they wear in a preferred brand (as discussed above in connection with block 703) to be matched with others who accordingly appear to have similar body types, size, and/or style preferences.

In embodiments, method 700 may branch to a right block 708 where the user may select a brand or style sub-group in order to further narrow/personalize his or her cohort group. For example, some consumers may typically shop at 1-5 preferred retailers or brands online and may choose to narrow their cohort group to members who shop at these certain retailers and/or purchase these particular brands. In embodiments, the user may choose to only see purchases from their cohort group members that fall under one or more types of articles of clothing or particular brands or classes of brands (e.g., designer, mid-range price or athletic wear, professional wear, etc.). In other embodiments, software associated with the computing device may automatically select a brand/store/style subgroup according to data submitted by the user.

In embodiments (not shown), block 708 can occur prior to or within block 707. In embodiments, selecting a brand/style sub-group may be a part of matching a user to find a cohort group. In other embodiments, block 708 may be skipped and the user's cohort group may not be narrowed to particular brands or styles.

In embodiments, at a next block 709, a suggested cohort group may be presented to the user. The user name or screen names as well as access to recent reviews or purchases by members of the cohort group may be provided. In embodiments, photos and other information of the subject articles of clothing may be presented to the user either on the website or via links to websites of the retailers where the subject articles of clothing may be purchased. In other embodiments, articles of clothing may be purchased directly on the website, rather than via the retailers' websites. In some embodiments, small icons representing recently reviewed or purchased articles may be displayed next to the user name of the individual member(s) of cohort group who reviewed/purchased the items. For example, small icons of, e.g., a V-neck sweater, pants, dresses, etc., including colors and styles of items reviewed/purchased during a particular recent period of time may be displayed. In embodiments, once the user clicks on the icon, more information about the purchase may be displayed. Note that in embodiments, users may include as much or as little information in their reviews. In embodiments, users may upload photos/video of the articles of clothing or of themselves wearing the article of clothing associated with the review.

In embodiments, after a block 709, the method may proceed to either a next block 770 or branch to a left block 711. In embodiments, at block 711, after reviewing the presented cohort group, the user may add or delete members from his or her cohort group. In embodiments, the user may edit the cohort group after browsing different members' profiles. Note that in embodiments, profiles of users/members may display as little or as much as the user/member desires. For example, some users may only display recent purchases while others may include actual measurements, weight, height, style preferences, geographic location, age range, etc., to determine whether users are a good ‘body double’ or ‘style double’ for each other.

Returning to method 700, in embodiments, after the user adds or deletes members from his or her cohort group, or if the user did not choose to modify his or her cohort group, the method flows to a next block 710. At a next block 710, a user may shop using one or more of the cohort group members' purchases and/or reviews as a guide. In embodiments, the user may click a link that takes the user to an online retailer's site to browse or purchase merchandise. In some embodiments, the user may be able to directly purchase the item via the website. In embodiments, some items may no longer be available depending on when the review was completed. In embodiments, this may be indicated in the review, photo, or icon, associated with the subject article of clothing. In embodiments, even though an item may no longer be available for purchase, the identifying information and review may remain on the website or dashboard for reference. Other cohort group members or potential cohort group members may browse such purchases which may help them to determine whether the user is a good ‘body double’ size-wise and/or style match.

In embodiments, the method 700 may move dynamically to and from block 711 as the user edits his or her cohort group. In the embodiment, according to the user's or cohort group members' latest reviews, members may be added or deleted from the user's cohort group. In embodiments, the cohort group members may be automatically added or suggestions made to edit the cohort group based on updated information related to fit and style of the user and/or member of the cohort group.

Note that the order or presentation of blocks in FIG. 7, 8, or 9 are only exemplary and deletions, additions, reordering of the blocks, may occur within the spirit of embodiments of the invention. Note that the functions presented in the blocks may occur via a wardrobe-assistant device and/or other computing device.

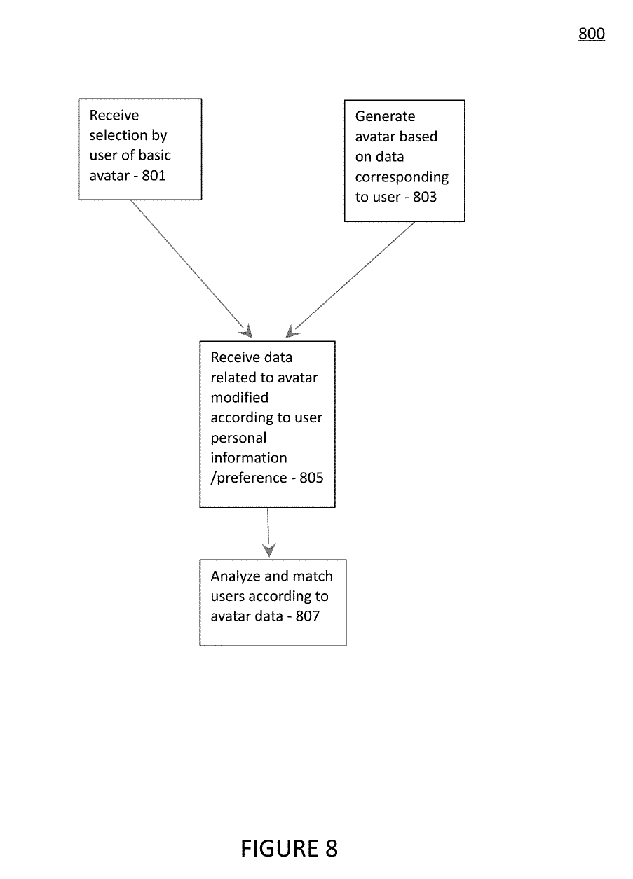

Next, FIG. 8 illustrates an embodiment associated with FIG. 7. In embodiments, an Avatar representing the user may be created at an apparel matching server (e.g. of FIG. 5) or selected via a wardrobe-assistant device or other computing device which reflects a preferred size, body type, etc., and in embodiments, style, of the user. In embodiments, the user may select a basic Avatar at a block 801, or in embodiments, an Avatar can be automatically generated based on data corresponding to the user at a block 803. Thus, if the user does not select his or her own basic or ‘starting Avatar’, in embodiments, the computing device may analyze data received in accordance with blocks 703 and 705 of FIG. 7 to present an Avatar to the user. In embodiments, a basic Avatar may include building blocks of an avatar with basic characteristics associated with the user. For example, the Avatar may be petite, skinny, tall, curvy, full-figured, broad-shouldered, etc.; the Avatar may reflect a user's hairstyle, color or skin tone as so desired. Thus, in the embodiment, data related to the user's selection of a basic avatar may be received at block 801. At a block 805, the user may modify/further modify the Avatar according to his or her personal information/preferences. For example, the user may either enter information that will modify the appearance and associated data of the Avatar or may dynamically change the Avatar's appearance. For example, the user may click and drag to increase or decrease a waist size, arm length, bust size, etc. In embodiments, as the user hovers a mouse or curser over different parts of the Avatar (which can in embodiments, be enlarged to screen size for editing or other purposes), a measurement or size associated with that portion of the body may appear, e.g. “28 inch waist” or “size 6 pants” etc., depending upon the information that the computing device may have in a database. In embodiments, for example, if the user decides to decrease or increase the size of his or her waist, as he/she drags the waist size larger, sizes associated with the changing dimension may appear on the screen so that he/she may stop when the appropriate size is reached. In embodiments, the size may appear as “size 6, XX brand.” In embodiments, these sizes may also be determined from information gathered from reviews.

In embodiments, after block 805, the method flows to a next block 807 where data/features associated with the Avatars may be analyzed and matched in conjunction with review information already gathered to assist in creating a cohort group for the user. In embodiments, block 807 may be similar to or correspond to block 707 of FIG. 7 where the inputted/extrapolated data related to a size and style of the user is analyzed to assist in placing the user with a cohort group. In embodiments, the actions associated with blocks 801, 803 and 805 can be included in or used in conjunction with the method described at blocks 703 and 705 in FIG. 7, where data related to the size/style/body type of the user is gathered.

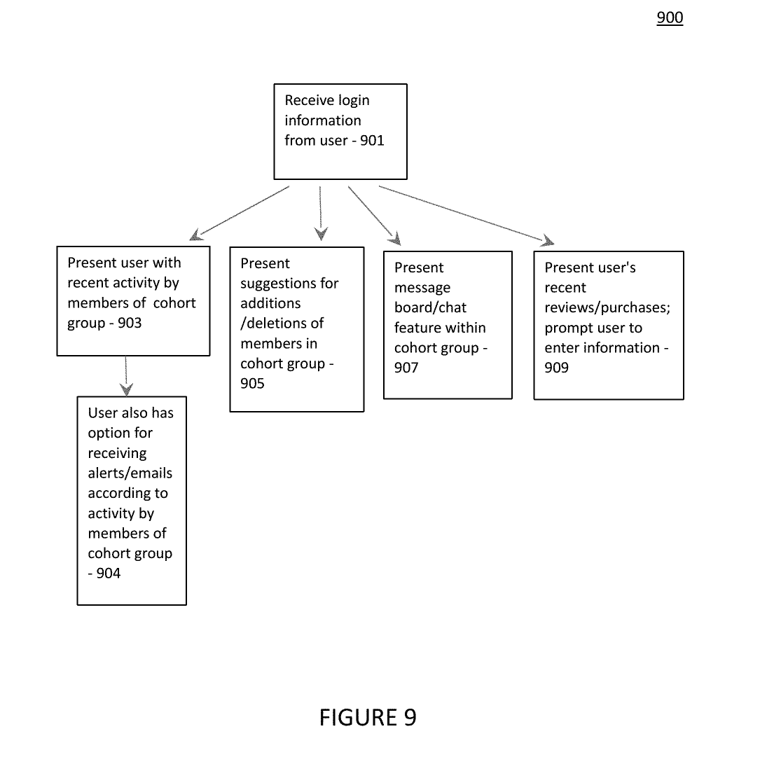

FIG. 9 illustrates an additional embodiment where a user can manage his or her apparel information collected via a wardrobe-assistant device and/or apparel matching sensors. In embodiments, at a block 901, login information may be received from the user or if utilizing the wardrobe-assistance device, no login may be required as the wardrobe-assistance device may already be associated with the user. In embodiments, once a password is received, a dashboard or initial screen may be presented to the user. In embodiments, one or more of blocks 903-909 may be included in the dashboard or initial screen. For example, at a block 903, information indicating recent activity by members of the user's cohort group may be presented. In embodiments, recent activity may include recent purchases, reviews, uploads, etc. by particular cohort group members. In embodiments, at a block 904, the user may be presented with an option to receive alerts/emails/texts notifying him/her of cohort group member activities. At a block 905, suggestions for additions/deletions of members in the user's cohort group may be presented. At a block 907, a message board/chat feature for the cohort group or other group as so selected or suggested may be available to the user. In embodiments, the user may request opinions or suggestions from their cohort group, or outside of their cohort group if so desired, regarding articles of clothing. For example, the user may request an opinion regarding a particular item of clothing they are considering purchasing. Or, in another example, a user may simply put out a request for suggestions for purchasing, e.g., a pair of black skinny jeans. In embodiments, at block 909, the user's “closet” can be presented, presenting the user's recent reviews or purchases. In embodiments, a user profile may also appear and can be edited by the user. In embodiments, the user may be prompted to enter additional information about his or her recent activity.

Note that in embodiments, the user may login to the website and enter reviews, purchase information, etc., using a mobile application (“app”) associated with the website on e.g., a smartphone or tablet. In embodiments, if a user would like to enter a review about an article of clothing, identifying information regarding the article of clothing may be received via a QR scan, UPC, or other barcode or electronic entry. In embodiments, the app may prompt the user for as little or as much review information that the user would like to enter. In embodiments, the user may rate the article using a rating system, e.g., 5-star system or a positive or negative answer to the question of whether they recommend this article of clothing or product.

Note that in embodiments, the website may be associated with providing a private label product and/or service to retailers. Thus, in embodiments, certain portions of the registration and data gathering as described above in relation to e.g., blocks 702-705 of FIG. 7, may be simplified or omitted in the case that the user is a customer of a retailer and his or her data is already accessible to one or more computing devices implementing the embodiment. Note that in some embodiments and as would apply to block 107, users who have purchased an identical item in an identical size from a same retailer with a positive review may be instantly placed into the same cohort group. In embodiments, a link presented on an online retailer's website may take the user to the present website in order to have the review and article of clothing included in the user's profile.

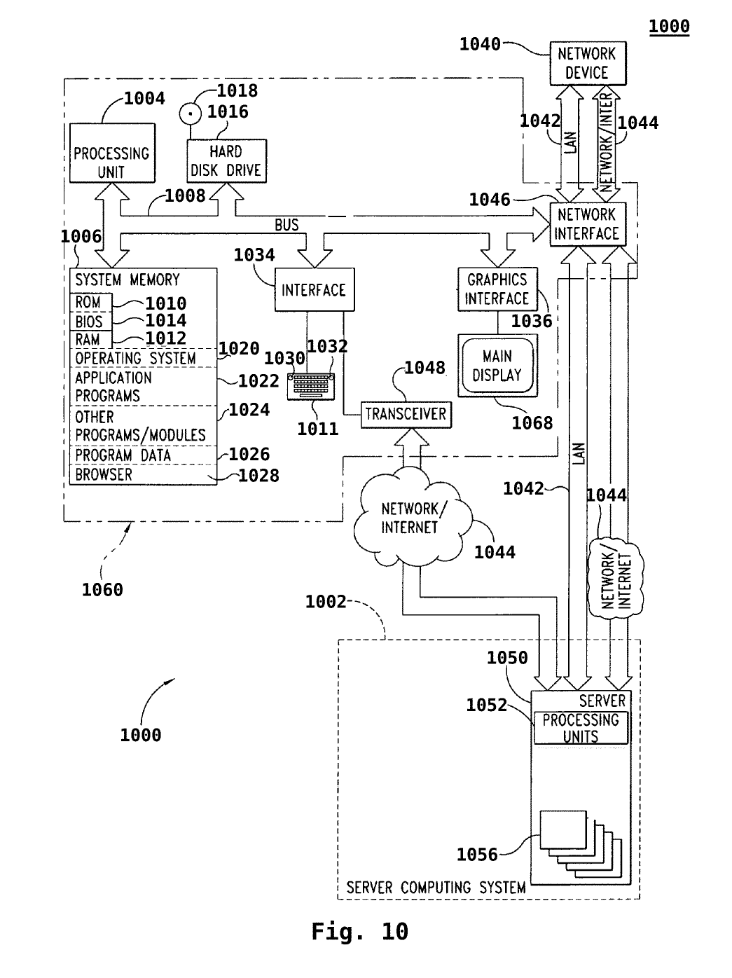

FIG. 10 and the accompanying discussion provide a description of a suitable computing environment in which embodiments as described above with respect to FIGS. 1-9 can be implemented. Embodiments can be implemented by hardware and computer-executable instructions, such as program application modules, objects, or macros that are capable of being executed by a computer. FIG. 10 shows a computing system 1000 and a network environment in which the computing system 1000 may be used. The computing system 1000 includes a computing device 1060 and a server computing system 1002. In various embodiments, computing device 1060 may be a desktop computer, portable computer such as for example a tablet or laptop, or other wired or wireless device. The server computing system 02 may be located at one or more network locations, to store and serve information for the computing device 1060 and other clients. Note that the below described components of and associated with computing device 1060 also apply to server computing system 1002.

The computing device 1060 includes a processing unit 1004, a system memory 1006, and a system bus 1008 that couples various system components including the system memory 1006 to the processing unit 1004. The processing unit 1004 may be any logic processing unit, such as one or more central processing units (CPUs), digital signal processors (DSPs), application-specific integrated circuits (ASICs), etc. The system bus 1008 can employ any suitable bus structure or architecture, including a memory bus with memory controller, a peripheral bus, and a local bus. The system memory 1006 includes read-only memory (ROM) 1010 and random access memory (RAM) 1012. A basic input/output system (BIOS) 1014, which can form part of the ROM 1010, contains routines that help transfer information between elements within the computing device, such as during start-up.

Computing device 1060 may include a hard disk drive 1016 for reading from and writing to a hard disk 1018. The hard disk drive 1016 communicates with the processing unit 1004 via the system bus 1008. The hard disk drive 1016 may include interfaces or controllers (not shown) coupled between such drive(s) and the bus 1008. The hard disk drive 1016 and its associated hard disk 1018 provide nonvolatile storage of computer readable instructions, data structures, program modules and other data. Among these computer readable instructions, which as noted above, may be located in server computing system 1002 as well, data structures, program modules and so forth are instructions, data structures and modules configured to implement one or more aspects of the earlier described applications described in connection with FIGS. 1, 2, and 3.

Although the depicted computing device employs the hard disk drive 1016 and the hard disk 1018, other types of drives and computer-readable media that are capable of storing data accessible by a computer may be employed, such as compact disks (CDs), magnetic cassettes, flash memory cards, digital video disks (DVDs), Bernoulli cartridges, RAMs, ROMs, smart cards, etc. In one embodiment, the hard disk drive 1016 and/or other drives are not integrated within a housing of the computing device 1060 itself, but instead are external devices that are accessible via hardwire or wireless communication interfaces.

Program modules can be stored in the system memory 1006, such as an operating system 1020, one or more application programs 1022, other programs or modules 1024, and program data 1026. An example operating system 1020 that may be used is Windows Server 2012™ commercially available from Microsoft Corporation of Redmond, Wash. The program data 1026 can be stored as a data structure, file, or other data format in a cache, database, or other storage unit integrated in or separate from the system memory 1006.

The computing device 1060 may also include a web browser 1028 for permitting the computing device 1060 to access and exchange data with sources such as Internet web sites, corporate intranets, or other networks as described below, as well as other server applications on server computers. For example, in embodiments, the information related to a user's cohort group may be provided to the user via a website or web page sent to the client device or computing device 1060 which displays the website using a browser. While shown in FIG. 10 as being stored in the system memory 1006, the operating system 1020, application programs 1022, other programs/modules 1024, program data 1026, and browser 1028 can be stored in the hard disk 1018 of the hard disk drive 1016 and/or other computer-readable media.

A user can enter commands and information into the computing device 1060 through input devices (such as the keyboard 1011) and a pointing device such as a mouse 1030. Alternatively or additionally, the mouse 1030 can be embodied as a touch pad as compared to physical buttons. Another input device may take the form of one or more buttons 1032 on the side of the keyboard 110, with the button(s) 1032 usable for scrolling and clicking via turning and pressing of the button(s) 1032. Other possible input devices can include a microphone, joystick, game pad, scanner, etc. (not shown). These and other input devices are connected to the processing unit 1004 through an interface 1034 such as a serial port interface that couples to the bus 1008, although other interfaces such as a parallel port, a game port or a wireless interface or a universal serial bus (USB) can be used. The interface 1034 can be any suitable communication interface to the bus 1008 and need not necessarily be a port per se.

The display screen 1068 operates as the main display and is coupled to the bus 1008 via a graphics interface 1036, such as a video adapter or other graphics component that will allow video and other graphics to be rendered on the display screen 1068. The computing device 1060 can operate in a networked environment using logical connections to one or more networked computers and/or devices, such as the server computing system 1002 and a network device 1040, such as a printer or network storage unit. The computing device 1060 is logically connected to one or more networked computing systems or devices under any suitable method of permitting computers to communicate, such as through a wireless local area network (LAN) 1042, a wireless wide area network (WWAN), or any other network 1044, including wired and wireless networks that use or can communicate with the Internet (e.g., World Wide Web). Other embodiments include other types of communication networks including telecommunications networks, cellular networks, paging networks, and other mobile networks. Examples of wireless systems and protocols with which the computing device 1060 can communicate, include but are not limited to, Wi-Fi, Bluetooth, 802.11, and others.

When used in a LAN networking environment, the computing device 1060 can be connected to the LAN 1042 through an adapter or network interface 1046 (communicatively linked to the bus 1008). When used in a WWAN or other network 1044, the computing device 1060 may include a modem, transceiver 1048 or other device, such as the network interface 1046, for establishing communications over this networking environment. The transceiver 1048 as shown in FIG. 10 is communicatively linked between the interface 1034 and the network 1044, for communicating between the computing device 1060 and the server computing system 1002, for instance.

In one embodiment, the computing device 1060 is communicatively linked to the server computing system 1002 through the LAN 1042 and/or the network 1044 with transmission control protocol/Internet protocol (TCP/IP) middle layer network protocols or other network protocol layers, such as User Datagram Protocol (UDP). The network connections shown in FIG. 10 are only some examples of establishing communication links between computers, and other links can be used, including both hardwire and wireless links.

The server computing system 1002 (which can comprise a hardware computing system, software computing system, or combination of both) includes one or more servers 1050. A server can provide analyzing size and apparel review services to match users according to size and style and may comprise hardware, software, firmware, or combinations thereof that provide such files and services, including for example, a single hardware server that runs multiple server software. The server 1050 can include one or more processing units 1052, which can comprise CPUs, controllers, processors, and the like, that work in conjunction with server applications for the routing of information between the computing device 1060 (and other clients) and the server computing system 1002.

Although specific embodiments have been illustrated and described herein for purposes of description of the preferred embodiment, it will be appreciated by those of ordinary skill in the art that a wide variety of alternate and/or equivalent implementations may be substituted for the specific embodiment shown and described without departing from the scope of the present invention. For example, in embodiments, the various types of articles of clothing, shoes, and/or accessories shown in the Figures are only illustrative. Accordingly, the apparel matching sensors described herein may be located in/on/integrated with any suitable article of clothing, shoe, or accessories including jewelry within the spirit of embodiments of the invention.

Those with skill in the art will readily appreciate that the present invention may be implemented in a very wide variety of embodiments. This application is intended to cover any adaptations or variations of the embodiments discussed herein.

We claim:

1) An apparatus, comprising an apparel matching sensor associated with a selected article of clothing, the apparatus comprising:
a transceiver;
a rechargeable power supply; and
a processor, operatively coupled to the transceiver and the rechargeable power supply, to operate the transceiver to:
transmit a wake-up signal to a plurality of apparel matching sensors associated with a corresponding plurality of other articles of clothing, wherein the wake-up signal includes or is accompanied by an identification of the selected article of clothing; and
receive a response signal from one or more of the plurality of apparel matching sensors, wherein the response signal indicates an apparel match between the selected article of clothing and an associated matching article of clothing in the corresponding plurality of other articles of clothing.

2) The apparatus of claim 1, further comprising an indicator coupled to the rechargeable power supply for indicating to a user, the apparel match between the selected article of clothing and the associated matching article of clothing, and wherein the indicator provides a light, a sound, symbols, or text and/or pattern of lights, sounds, symbols, or text and the light, the sound, symbols, or text and/or the pattern of lights, sounds, symbols of text to further indicate a hierarchical level associated with the apparel match.

3) (canceled)

4) The apparatus of claim 1, further comprising a detector, to detect an activation by a user of the apparel matching sensor associated with the selected article of clothing, and wherein the detector comprises a pressure sensor such as, including, but not limited to, a button or touch sensor.

5) (canceled)

6) The apparatus of claim 1, wherein the rechargeable power supply is a rechargeable battery charged by a current generating fabric of the selected article of clothing or a photo sensor included on or in a fabric of the selected article of clothing.

7) The apparatus of claim 1, wherein the apparel matching sensor is integrated into a clothes hanger associated with the article of clothing.

8) The apparatus of claim 1, further comprising the selected article of clothing and wherein the selected article of clothing comprises a garment made of washable power generating fabric to charge the rechargeable power supply.

9) (canceled)

10) The apparatus of claim 1, wherein the response signal from one or more of the plurality of apparel matching sensors of the associated matching article of clothing further includes a suggestion of an additional matching article of clothing to match the selected article of clothing and the associated matching article of clothing.

11) The apparatus of claim 10, wherein upon receipt of the suggestion of the additional matching article of clothing, the apparel matching sensor of the selected article of clothing to communicate directly with an apparel matching sensor of the associated matching article of clothing to indicate an additional apparel match.

12) The apparatus of claim 1, wherein the response signal from one or more of the plurality of apparel matching sensors further includes a suggestion of a matching garment associated with a body double of a user and available for purchase through an associated closet device.

13) A wardrobe-assistant device for providing a user with a fashion match suggestion for a first garment located proximate to the wardrobe-assistant device in a wardrobe or clothing storage area of the user, the wardrobe-assistant device comprising:
a processor;
a memory coupled to the processor; and
a scanner operatively coupled to the processor and the memory and configured to receive information from an apparel matching sensor located in or on the first garment, wherein the processor to utilize the information to assist in providing the fashion match suggestion including at least the first garment and a second garment.

14) The wardrobe-assistant device of claim 13, further comprising a radiofrequency (RF) source to broadcast energy to provide charge to the apparel matching sensor and a plurality of additional apparel matching sensors in a location proximate to the wardrobe-assistant device.

15) The wardrobe-assistant device of claim 13, further including a display screen operatively coupled to the processor and the memory to display fashion match suggestions including the first garment and a second garment.

16) The wardrobe-assistant device of claim 15, wherein the fashion match suggestion to further include garments associated with a review written by a body double of the user and the review is included on a website of an online retailer associated with the user.

17) The wardrobe-assistant device of claim 16, wherein wardrobe-assistant device is a smart phone.

18) One or more non-transitory computer-readable media (CRM) comprising instructions that cause a remote management server, in response to the execution of the instructions by the remote management server, to:
receive an identifier of an apparel matching sensor from a wardrobe-assistant device communicatively coupled to the apparel matching sensor and associated with a selected article of clothing;
use the received identifier to determine an apparel match between the selected article of clothing and one or more matching articles of clothing; and
transmit information associated with the apparel match to the wardrobe-assistant device.

19) The one or more non-transitory computer-readable media of claim 18, wherein the one or more matching articles of clothing is identified as proximate to the wardrobe-assistant device via one or more additional plurality of apparel matching sensors communicatively coupled to the wardrobe-assistant device.

20) The one or more non-transitory computer-readable media of claim 18, wherein the received identifier is assigned by a retailer or manufacturer to the article of clothing.

21) The one or more non-transitory computer-readable media of claim 18, wherein the identifier of the apparel matching sensor is provided to the remote management server to allow the remote management server to further determine a body double suggestion for a user based on a size and style of the selected article of clothing and to transmit the body double suggestion to the wardrobe-assistant device.

22) The one or more non-transitory computer-readable media of claim 18, wherein to transmit information associated with the apparel match to the wardrobe-assistant device includes to transmit an image of an outfit of an online fashion board.

23) The apparatus of claim 1, wherein the response signal from one or more of the plurality of apparel matching sensors incorporates information resulting from a communication between the one or more of the plurality of apparel matching sensors and another of one or more of the plurality of apparel matching sensors.
